(19) United States
(12) Patent Application Publication
(10) Pub. No.: US 2005/0167434 A1
(43) Pub. Date: Aug. 4, 2005

(54) Storage tank for cryogenic media and method of using and making same

(75) Inventor: Wilfried-Henning Reese, Unterschleissheim (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 10/987,200

(22) Filed: Nov. 15, 2004

(30) Foreign Application Priority Data
Nov. 14, 2003 (DE) 103 53 382.6

(51) Int. Cl. B60P 3/00

(52) U.S. Cl. 220/564

(57) ABSTRACT

A storage tank for liquid hydrogen has an outer tank, at least one inner tank, an insulation arranged between the outer tank and the inner tank or tanks and has at least one metallic layer, and at least one filling and/or removing line. The at least one filling and/or removing line are/is in a direct and/or indirect thermal contact with the metal layers or at least one of the metal layers of the insulation.

### BACKGROUND AND SUMMARY OF THE INVENTION

This application claims the priority of German Application No. 103 53 382.6 filed Nov. 14, 2003, the disclosure of which is expressly incorporated by reference herein.

The invention relates to a storage tank, particularly a storage tank for low-temperature liquids, preferably for liquid hydrogen, having an outer tank, at least one inner tank, an insulation arranged between the outer tank and the inner tank or tanks and having at least one metallic layer, as well as at least one filling and/or removing line.

In the following, the designations of special cryogenic media, corresponding to their state of aggregation, will be preceded by the letters “G” for “gaseous” and “L” for “liquid”: Thus, for example, GH₂ and LH₂ respectively for gaseous and liquid hydrogen.

Hydrogen is currently becoming increasingly significant as an energy carrier because of rising energy demands and higher environmental awareness. Thus, trucks, buses as well as passenger cars are already powered by means of hydrogen-operated engines or fuel cells. Furthermore, first experiments are being carried out with respect to propelling airplanes by means of the above-mentioned media.

Storage of hydrogen “onboard” the above-mentioned transport devices makes the most sense in liquid form. Although, the hydrogen must be cooled to approximately 21° K and has to be maintained at this temperature—which can be implemented only by corresponding insulating measures on the storage containers or tanks—, because of the low density of GH₂, a storage in the gaseous state, as a rule, is less advantageous in the above-mentioned transport devices because, in this case, the storage has to take place in large-volume heavy storage tanks at high pressures.

If, for a fairly long time period, no medium is removed from such storage tanks, a rise of the temperature and pressure will occur in the interior of the inner tank in the medium stored therein because of the incidence of heat onto the inner tank from the environment, which cannot be prevented. Corresponding to the pressure-related design of the inner tank, gaseous medium then has to be released or blown off from time to time from the storage tank by way of a filling and/or removing line—in which a pressure relief valve, for example, is provided—. If the storage tank is provided in a motor vehicle, this quantity of the gaseous medium is unutilized unless an additional storage device, such as a metal hydride storage device, is provided for the medium quantity to be blown off.

Conventional storage tanks for liquid hydrogen permit service lives of from two to three days before evaporation and therefore a loss of gaseous hydrogen occur. The acceptance of hydrogen as an energy carrier—particularly in the case of passenger cars—will, among other things, also depend on the possible length of the service life of a passenger car. A blowing-off of hydrogen after two to three days will certainly not be accepted by the customer.

It has been suggested to arrange, at a certain temperature level, an aluminum or copper shield, which as a rule completely surrounds the inner tank, inside the intermediate space of storage tanks of the above-mentioned type and thermally spot-weld it to a removal line by way of which the evaporated cryogenic medium is withdrawn from the inner tank. This aluminum or copper shield will then be cooled (again) by the flowing-off cryogenic medium during each blowing-off of cryogenic medium. The heat flow which comes in from the environment up to the temperature level at which the aluminum or copper shield is arranged, as a result of the warming of the cryogenic medium to be blown off, is absorbed by the latter and is returned to the outside. As a result, the heat flow onto the inner tank can be significantly reduced. In principle, several aluminum or copper shields can also be provided, whereby the insulating effect is further improved. However, the constructive expenditures for such storage tanks are considerable.

It is an object of the invention to provide a storage tank of the above-mentioned type, where the heat incidence on to the medium stored in it is reduced and which, by means of simple devices, permits a clear reduction of the quantity of medium to be blown off and thus a lengthening of the service lives.

For achieving this object, a storage tank is provided which is characterized in that the filling and/or removing lines or at least one of the filling and/or removing lines are/is in a direct and/or indirect thermal contact with the metallic layer of the insulation or at least one of the metallic layers of the insulation.

The insulation of storage tanks, which are used for the storage of cryogenic liquids or media, as a rule, is achieved by means of a so-called superinsulation. The latter consists of several layers of thin aluminum foils and/or aluminized foils with a glass fiber fabric situated in-between or a glass fiber nonwoven layer situated in-between. The glass fiber fabric and the glass fiber nonwoven layer prevent that the aluminum foils and/or the aluminized foils contact one another and thus trigger a thermal short circuit.

According to the invention, now the filling and/or removing line or at least one of the filling and removing lines is in a thermal contact with at least one of the metallic layers of the insulation. Instead of the previously used aluminum or copper shields, now the existing metallic layers of the insulation are used as shields. Conventionally, superinsulations as a rule have between 30 and 80 metal layers, so that each of the latter can act as an individual shield. When a filling and/or removing line is brought in thermal contact with several of the metallic layers, each shield now has to divert a fraction of the heat which previously—when an individual aluminum or copper shield was used—had to be diverted by a single shield.

The thermal connection between the filling and/or removing line or lines as well as of the metallic layer or layers of the insulation can have either a direct and/or indirect construction. A direct thermal contact can take place, for example, by means of a metal bonding tape, a heat-conducting adhesive and/or a heat-conducting paste. However, even by means of an indirect thermal contact according to certain preferred embodiments of the invention—thus, by means of the transmission of thermal energy by radiation—a sufficient transfer of the required cooling energy is caused from the filling and/or removing line to the metallic layer(s).

By means of the invention, it is now achieved that the quantity of evaporated cryogenic media to be blown off is reduced so far or becomes negligibly low that this above-described disadvantage should no longer stand in the way of the acceptance, particularly of the hydrogen medium. When now, for example, additionally a metal hydride storage device is provided in a motor vehicle having a storage tank according to certain preferred embodiments of the invention, by means of this metal hydride storage device, the small quantity of medium to be blown off can be collected and stored.

In principle, a large number of configurations between the metallic layer or layers and the filling and/or removing line or lines are conceivable according to respective different preferred embodiments of the invention. Thus, for example, only each second or third metallic layer can be connected with a filling and/or removing line. However, for example, also several filling and/or removing lines can be brought into a thermal contact with several metallic layers.

As a further development of the storage tank according to certain preferred embodiments of the invention, it is suggested that, in the case of those constructions in which the inner tank or tanks is/are connected by means of a holding device with the outer tank, the filling and/or removing lines or at least one of the filling and/or removing lines are/is in a direct and/or indirect thermal contact with the holding device.

By means of this advantageous further development of the storage tank according to the invention, it is achieved that also the holding device connecting the inner tank or tanks with the outer tank is cooled by cryogenic medium to be blown off, whereby the incidence of heat by way of the holding device onto the inner tank or tanks is also reduced.

According to an advantageous further development of the storage tank according to certain preferred embodiments of the invention, the thickness of the metallic layer(s), which is or are in a thermal contact with at least one of the filling and/or removing lines, amounts to 0.006 to 0.15 mm. In particularly preferred embodiments, the thickness of the metallic layers is between 0.01 to 0.05 mm.

While the previously used aluminum or copper shields have a thickness of between 0.1 and 0.3 mm, now considerably smaller thicknesses can be implemented according to certain preferred embodiments of the invention. This has the result that standard-type insulations or insulation systems can be used.

Another advantage resulting from certain preferred embodiments of the invention consists of the fact that—if separate lines are provided for the blowing-off of the evaporated cryogenic medium out of the inner tank—, these can be constructed with a smaller diameter because, in the case of the storage tank according to the invention in contrast to the storage tank constructions of the prior art, the quantity of the medium to be blown off is considerably reduced. By means of the implementation of thinner lines, these can be mounted or wound (on) together with the insulation during the production of the storage tank according to the invention. Normally, the mounting of the insulation takes place by winding of the individual layers onto the (slowly) rotating inner tank.

Furthermore if several lines are in a thermal contact with the metallic layer or layers of the insulation, it is recommended according to certain preferred embodiments of the invention, to bring these lines in a thermal contact with the individual metallic layers such that the heat distribution in the individual metallic layers is as homogeneous as possible.

The storage tank according to the invention as well as further developments thereof, which represent the object of the dependent claims, will be explained in detail in the following by means of the embodiment illustrated in the drawings.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic sectional view of a storage tank for low-temperature liquids, such as liquid hydrogen, constructed according to a preferred embodiment of the present invention; and

FIG. 2 is a schematic sectional view of the tank of FIG. 1, taken along a plane perpendicular to the plane of FIG. 1.

### DETAILED DESCRIPTION OF THE DRAWINGS

A storage tank—as used, for example, in motor vehicles operated with liquid hydrogen—has an outer tank 1, and inner tank 2, in which the medium 3 to be stored is situated; and several metallic layers 6, 6′, 6″, . . . arranged between the outer tank 1 and the inner tank 2. The metallic layers 6, 6′, 6″ . . . form the required (super) insulation.

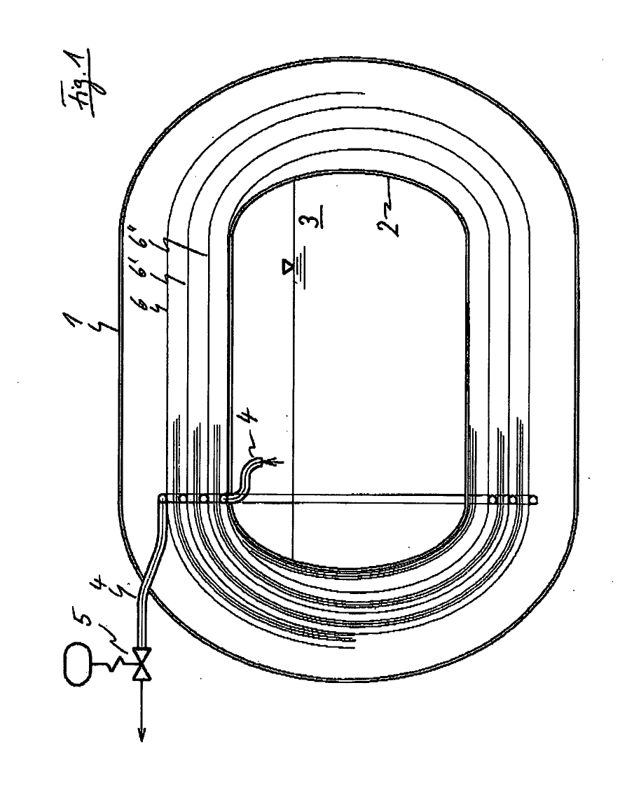

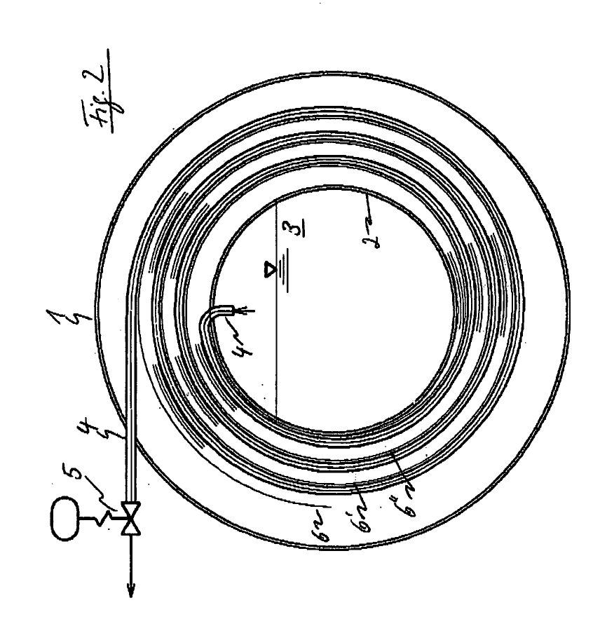

For reasons of clarity, the filling and removing lines are not shown in FIGS. 1 and 2. It should be stressed that these may be separate lines or a single line which is used for the filling as well as for the emptying of the storage tank.

Furthermore, as a rule, such storage tanks have a discharge or overflow line 4. In the following, a discharge or overflow line should be considered to be a removal line. Outside the outer tank 1, a safety valve 5 is arranged in this overflow line 4, which opens automatically, for example, in the event of an exceeding of a set threshold pressure value, and thus permits a relieving of the storage tank, particularly of the inner tank 2.

According to the invention, the overflow line 4 is now in a thermal contact with the above-mentioned metallic layers 6, 6′, 6″ . . . . Thus, when hydrogen is removed by way of the overflow line 4—as indicated by the arrows—the metallic layers 6, 6′, 6″, . . . , which are in a thermal contact with the overflow line 4, are cooled (again).

The filling and removing lines, which are not shown in FIGS. 1 and 2, can also be in a direct and/or indirect thermal contact with the metallic layers of the insulation. If several filling and/or removing lines are provided, according to the invention, at least one of the filling and/or removing lines is in a direct and/or indirect thermal contact with the metallic layers of the insulation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Storage tank for low-temperature liquid hydrogen, having an outer tank, at least one inner tank, an insulation arranged between the outer tank and the at least one inner tank and having at least one metallic layer, and at least one filling and/or removing line,
wherein at least one of the at least one filling and/or removing lines is in a thermal contact with at least one metallic layer of the insulation.

2. Storage tank according to claim 1, wherein the insulation includes a plurality of said metallic layers in thermal contact with the at least one filling and/or removing lines.

3. Storage tank according to claim 1, wherein the thermal contact is direct thermal contact.

4. Storage tank according to claim 2, wherein the thermal contact is direct thermal contact.

5. Storage tank according to claim 1, wherein at least one inner tank is connected by way of a holding device with the outer tank, and
wherein the at least one filling and/or removing line is in a direct and/or indirect thermal contact with the holding device.

6. Storage tank according to claim 1, wherein the thickness of the metallic layer(s), which is/are in a thermal contact with at least one of the filling and/or removing lines, amounts to from 0.006 to 0.15 mm.

7. Storage tank according to claim 6, wherein the thickness amounts to from 0.01 to 0.05 mm.

8. Storage tank according to claim 2, wherein at least one inner tank is connected by way of a holding device with the outer tank, and
wherein the at least one filling and/or removing line is in a direct and/or indirect thermal contact with the holding device.

9. Storage tank according to claim 2, wherein the thickness of the metallic layer(s), which is/are in a thermal contact with at least one of the filling and/or removing lines, amounts to from 0.006 to 0.15 mm.

10. Storage tank according to claim 3, wherein at least one inner tank is connected by way of a holding device with the outer tank, and
wherein the at least one filling and/or removing line is in a direct and/or indirect thermal contact with the holding device.

11. Storage tank according to claim 3, wherein the thickness of the metallic layer(s), which is/are in a thermal contact with at least one of the filling and/or removing lines, amounts to from 0.006 to 0.15 mm.

12. Use of a storage tank according to claim 1, as a mobile storage tank, particularly as a storage tank for motor vehicles.

13. Use of a storage tank according to claim 2, as a mobile storage tank, particularly as a storage tank for motor vehicles.

14. Use of a storage tank according to claim 3, as a mobile storage tank, particularly as a storage tank for motor vehicles.

15. Use of a storage tank according to claim 5, as a mobile storage tank, particularly as a storage tank for motor vehicles.

16. Use of a storage tank according to claim 6, as a mobile storage tank, particularly as a storage tank for motor vehicles.

17. Storage tank for liquid hydrogen comprising:
an outer tank,
an inner tank disposed inside the outer tank,
insulation disposed between the outer and inner tanks, said insulation including a plurality of metallic layers separated by glass fiber layers, and
a line extending from the inner tank through the insulation and the outer tank for accommodating flow of hydrogen between the inner tank and an area outside of the outer tank,
wherein said line is in thermal contact with at least one of said metallic layers.

18. Storage tank according to claim 17, wherein said line is in thermal contact with a plurality of said metallic layers.

19. Storage tank according to claim 17, wherein the thermal contact is direct thermal contact.

20. Storage tank according to claim 18, wherein the thermal contact is direct thermal contact.

21. Storage tank according to claim 18, wherein the thickness of the metallic layers in thermal contact with the line is between 0.006 mm and 0.15 mm.

22. Storage tank according to claim 20, wherein the thickness of the metallic layers in thermal contact with the line is between 0.006 mm and 0.15 mm.

23. Storage tank according to claim 21, wherein said thickness of the metallic layers in thermal contact when the line is between 0.01 mm and 05 mm.

24. Storage tank according to claim 22, wherein said thickness of the metallic layers in thermal contact when the line is between 0.01 mm and 05 mm.

25. Storage tank according to claim 17, wherein a holding device separate from the insulation connects the inner and outer tanks with one another, and
wherein the line is in thermal contact with the holding device.

26. Storage tank according to claim 18, wherein a holding device separates from the insulation connects the inner and outer tanks with one another, and
wherein the line is in thermal contact with the holding device.

27. Storage tank according to claim 23, wherein a holding device separates from the insulation connects the inner and outer tanks with one another, and
wherein the line is in thermal contact with the holding device.

28. Use of the storage tank according to claim 17, as a mobile storage tank for holding hydrogen for supplying energy to a motor vehicle carrying the storage tank.

29. Use of the storage tank according to claim 20, as a mobile storage tank for holding hydrogen for supplying energy to a motor vehicle carrying the storage tank.

30. Use of the storage tank according to claim 23, as a mobile storage tank for holding hydrogen for supplying energy to a motor vehicle carrying the storage tank.

31. Use of the storage tank according to claim 27, as a mobile storage tank for holding hydrogen for supplying energy to a motor vehicle carrying the storage tank.

32. A method of making a liquid hydrogen storage tank for a motor vehicle comprising:
providing an inner tank for holding liquid hydrogen,
wrapping said inner tank with a superinsulation including a plurality of alternating layers of glass fiber and thin metal sheets,
disposing said inner tank and superinsulation inside an outer tank, and
disposing a line extending from the inner tank through the superinsulation and the outer tank for accommodating flow of hydrogen between the inner tank and an area outside the outer tank,
wherein said line is in thermal contact with a plurality of said layers formed of thin metal sheets.

33. A method according to claim 32, wherein the thermal contact is direct thermal contact.

34. A method according to claim 33, wherein said thin metal sheets layers have a thickness of between 0.006 mm and 0.15 mm.

35. A method according to claim 34, wherein said thin metal sheet layers have a thickness of between 0.01 mm and 0.05 mm.

36. A method according to claim 32, wherein said plurality of thin metal sheet layers include between 30 and 80 metal sheet layers.

37. A method according to claim 32, wherein said thermal contact includes connecting the respective metal sheet layers with the line by metal bonding tape.

38. A method according to claim 32, wherein said thermal contact includes connecting the respective metal sheet layers with the line by heat conducting adhesive or heat conducting paste.

39. A method according to claim 32, wherein all of said metal sheet layers are in direct thermal contact with the line.

40. A method according to claim 32, wherein between one third and one half of the metal sheet layers are in direct thermal contact with the line.

41. A method according to claim 36, wherein all of said metal sheet layers are in direct thermal contact with the line.

42. A method according to claim 36, wherein between one third and one half of the metal sheet layers are in direct thermal contact with the line.

43. A method according to claim 41, wherein said thermal contact includes connecting the respective metal sheet layers with the line by metal bonding tape.

44. A method according to claim 42, wherein said thermal contact includes connecting the respective metal sheet layers with the line by metal bonding tape.
